(19) United States
(12) Patent Application Publication
(10) Pub. No.: US 2018/0071808 A1
(43) Pub. Date: Mar. 15, 2018

(54) A STACKING LINE SYSTEM, AND A METHOD FOR STACKING BLANKS WHICH ARE OUTPUTTED FROM A BLANKING SHEAR OR PRESS

(71) Applicant: ABB SCHWEIZ AG, Baden (CH)

(72) Inventors: Antonio Lorenzo VIÑUALES DUESA, Barcelona (ES); Ramon CASANELLES MOIX, Sant Cugat Del Valles (ES)

(73) Assignee: ABB SCHWEIZ AG, Baden (CH)

(21) Appl. No.: 15/565,642

(22) PCT Filed: Apr. 10, 2015
(86) PCT No.: PCT/EP2015/057823

§ 371 Date: Oct. 10, 2017

(51) Int. Cl. B21D 43/00; B21D 43/22; B25J 9/00

(52) U.S. Cl. CPC B21D 43/003; B25J 9/0096; B25J 9/0018; B21D 43/22

(57) ABSTRACT

Included are a transfer unit for receiving blanks outputted from the blanking shear or press; at least one stacking support for stacking blanks thereon; one or more stacking robots to pick blanks from the transfer unit and place them on the stacking support, and at least one handling robot configured to position one or more centering pins for assisting the placement of the blanks on the stacking support.

The present disclosure relates to a stacking line system which includes a transfer unit for receiving the blanks outputted from a blanking shear or press, and stacking supports for stacking the blanks thereon.

### BACKGROUND

In the production of stamped or pressed metal parts, such as for example vehicle parts, presses may be supplied with metal blanks that have previously been cut from a metal coil in a separate blanking line. The blanks may be simple metal sheets of a predetermined length or have trapezoidal shapes (shear cutting by a blanking shear), or may present more complex outer shapes, cut-outs, etc. (shape cutting in a blanking press with a cutting die). Blanks produced in a blanking line must be orderly stacked on stacking pallets, trolleys, carts or similar supports, in order to be later moved away from the stacking line and fed one by one to a press line or simply stored for later use or transportation to another production site.

WO2013185834 A1 discloses a system for stacking blanks which includes two industrial robots, arranged such that they are operable in an individual operating mode in which each robot picks a blank from the transfer unit and places it on a stacking support, and a joint operating mode in which a group of robots act simultaneously on one and the same blank, to pick it from the transfer unit and place it on the stacking support.

It has now been found that the speed of a stacking system using stacking robots such as disclosed in WO2013185834 A1 may be further improved without losing accuracy.

### SUMMARY

In a first aspect, the present subject matter may provide a stacking line system for stacking blanks outputted from a blanking shear or press, the stacking line system may include a transfer unit for receiving blanks outputted from the blanking shear or press, at least one stacking support for stacking blanks thereon, one or more stacking robots to pick blanks from the transfer unit and place them on the stacking support, and a blanks guiding system that may include at least one handling robot configured to position one or more adjustable centering pins for assisting the placement of the blanks on the stacking support.

Such placement assistance may involve guiding each blank in its vertical descent towards the stacking support, or at least in the last part of the movement, and/or adjusting the position of each blank once it has reached the stack of blanks on the support, so that all the blanks on a stack are substantially aligned or even with each other. The provision of such a system may avoid the problem of air cushion effect that may cause errors in their positioning on the stacking support.

Furthermore, stacking robots don't need to place the blanks on the stack in a very accurate manner and may drop them from a distance above the stacking support, and may therefore operate faster, increasing velocity rates and thus improving the overall system's efficiency. In some examples a high accuracy may be achieved, for example +/−0.5 mm, without the need for introducing further complex and expensive systems.

In some examples, the adjustable centering pins of the centering system are pins intended to be attached to the stacking support. In these examples, the need of external pins or handling robots to position the adjustable centering pins is avoided. Instead, a handling robot is used in order to attach the pins to the stacking support.

In some examples, the subject matter hereof may provide centering pins that are configured to be attached to the stacking support in a releasable fashion. In some implementations, the centering pins may include magnetic releasable elements, and the stacking support may be made of a ferromagnetic material. These examples provide high versatility due the ability of the system to adapt to any shapes and sizes of the blanks.

In a second aspect, the subject matter hereof may provide a method for stacking blanks outputted from a blanking shear or press, including providing a stacking support, positioning one or more adjustable centering pins in correspondence with the stacking support, by a handling robot, in predetermined positions depending on the blanks to be stacked, and stacking blanks on the stacking support by a stacking robot, such that the placement of the blanks on the stacking support is assisted by the adjustable centering pins.

Additional objects, advantages and features of examples of the present subject matter will become apparent to those skilled in this area upon examination of the description, or may be learned by practice of the present subject matter.

### BRIEF DESCRIPTION OF THE DRAWINGS

Particular examples of the present subject matter will be described in the following by way of non-limiting examples, with reference to the appended drawings, in which:

FIG. 1A schematically illustrates in plan view a stacking line system according to some examples, with fixed centering pins and handling robots positioning adjustable centering pins;

FIG. 1B schematically illustrates in plan view a stacking line system according to some examples, with magnetic fixed centering pins and handling robots positioning magnetic adjustable centering pins;

FIG. 1C schematically illustrates in plan view a stacking line system according to another example, with two handling robots positioning two adjustable centering pins;

FIGS. 2A and 2B are schematic drawings in plan view of stacking line systems according to examples of the disclosure, with a handling robot displacing non-magnetic frame-mounted centering pins.

FIG. 3 is a plan view drawing showing a stacking line system according to a further example, with a handling robot displacing magnetic frame-mounted centering pins.

FIG. 4 schematically illustrates a stacking line system according to an example, with a combination of frame-mounted pins and robot-mounted pins.

FIG. 5 illustrates a perspective view of a stacking line system according to an example, with a handling robot displacing non-magnetic frame-mounted centering pins.

FIG. 6 illustrates a perspective view of a stacking line system according to an example, with frame-mounted pins.

FIG. 7 illustrates a lateral view of a frame-mounted pin in detail.

FIG. 8 illustrates a perspective view of a stacking line system according to an example of the disclosure, with a handling robot positioning detached centering pins, and stacking supports being located on one side of the stacking line system.

FIGS. 9A and 9B illustrate a perspective view of a stacking line system according to an example of the disclosure, with two stacking supports exchanging places at one same side of the line.

FIG. 10 illustrates a further example of a stacking line system with stacking supports located on both sides of the stacking line system.

FIG. 11 schematically illustrates some examples of blank geometries that may be outputted from a blanking shear or press.

### DETAILED DESCRIPTION OF EXAMPLES

In a blanking shear or press, blanks of rectangular or trapezoidal shape are cut by a shear from a metal coil. Blanks with more complex shapes may also be formed by a contoured blanking die. These blanks are work pieces on which later on further operations may be performed, for instance in a press line. To this end, the blanks outputted from the blanking shear or press are stacked in a stacking line arranged adjacent the blanking shear or press.

FIG. 11 shows by way of example some blanks 1 that may be outputted from a blanking shear or press.

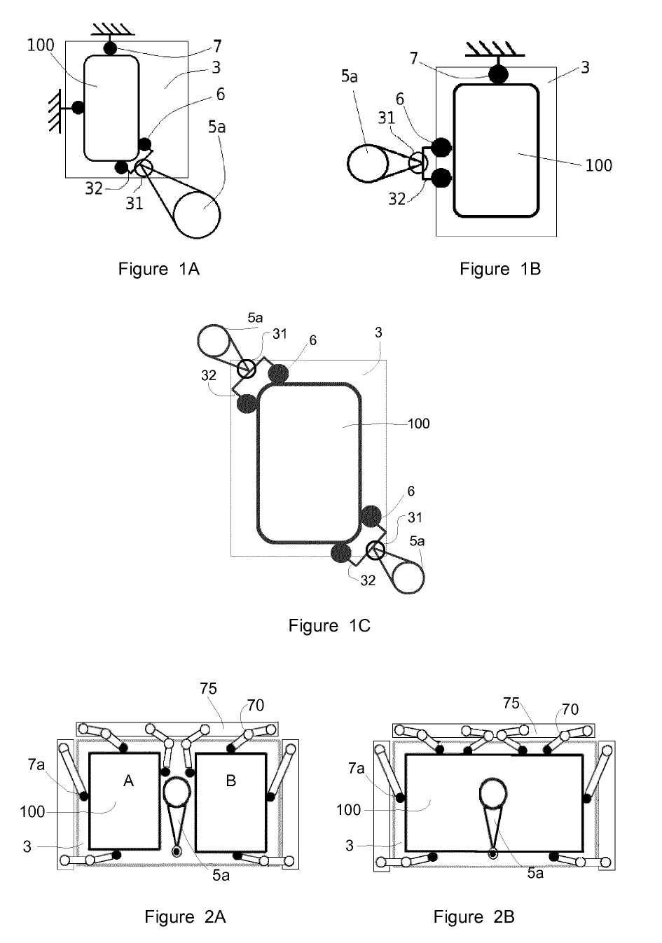

FIG. 1A is a schematic drawing showing a stacking line system according to an example of the present subject matter. The system may include as shown stacking supports 3 for stacking blanks thereon, such that they can be later transported to another production line for further handling. The stacking supports 3 may be of any known type. The stacking line system in this example may include a blank guiding system wherein two fixed centering pins 7 are associated with two contiguous sides of the stacking support 3, and a handling robot 5a holding the two adjustable centering pins 6 on the sides of blanks 100 which are substantially orthogonal to the mentioned contiguous sides.

Robot 5a may be controlled by a controller (not shown) to hold two adjustable centering pins 6 and place them on the side of an associated blank 100 which lies on a stacking support 3. The robot may be a four axis robot. Two adjustable centering pins 6 are attached to a U-shaped structure 32, which is mounted on the fourth axis 31 of the robot so that pins 6 can rotate as the fourth axis moves. Handling robots 5 (which includes and is defined, e.g., by robots 5a, 5b, 5c, and 5d, inter alia) might be six axis robots as well, in which case the structure 32 might be mounted on the sixth axis.

A stacking robot (not shown), for example a suitable industrial robot, may pick up a blank 100 from a transfer unit of the blanking line (not represented) and place it on the stacking support 3. During this operation the handling robot 5a is holding the two adjustable centering pins 6 at a suitable position, which depends on the shape of the blanks being stacked.

By the expression “industrial robot” it is here meant an automatically controlled, reprogrammable, multipurpose, manipulator programmable in three or more axes, which may be either fixed in place or mobile for use in industrial automation applications, as defined by the International Organization for Standardization in ISO 8373.

The use of pins around the perimeter of the blanks 100 facilitates the centering of the blanks as they are stacked, so that stacking may be performed in a fast and precise manner. In addition, the use of fixed pins allows using a single handling robot 5a with adjustable pins, which has a relatively low cost and leaves plenty of space for operation of the stacking robot.

In some examples, centering pins may be provided with magnets. In this case, since blanks may be attracted towards the pins, they may be guided by pins on two sides instead of four.

FIG. 1B shows a schematic drawing according to such an example. The adjustable centering pins 6, 7 having magnets may also perform a more accurate centering of the blanks 100. This disposition of the pins may further facilitate operation through increased free space around the stacking support, as well as it may provide a reduction of costs due to a decrease in the number of pins.

The fixed pins 7 may be attached to a frame adjacent the stacking support, or may be attached to the stacking support itself. The frame should be rigid enough as to guarantee a vertical position of the pins. For example, the frame may be a metal machined and levelled base.

FIG. 1C shows a schematic drawing according to a further example of the disclosure. The blanks guiding system in this example includes two handling robots 5a. Each robot is configured to position—during the stacking operation-adjustable centering pins 6 in correspondence with two sides of the stacking support 3 that are orthogonal to each other, which may provide the system with high adaptability to possible shapes of the blanks 100 and good stacking accuracy. In some examples, the centering pins may be magnetic. In such case, especially for small dimension blanks, only one handling robot may be sufficient for the guiding task. In such cases, a single robot may guide a stack of small dimension blanks, thus providing very good stacking efficiency.

In the examples shown in FIGS. 1A, 1B and 1C the guiding system may include one handling robot 5a. An example of an industrial robot suitable to be employed as handling robot in such a guiding system is IRB 260 (4 axes) or IRB 1600 (6 axes), available from ABB (www.abb.com), among others.

FIGS. 2A and 2B show schematically a stacking line system according to examples of the disclosure. A handling robot 5a displaces and positions the frame-mounted pins 7a, which are distributed around the perimeter of the stack. In this example, frame-mounted pins 7a are attached by articulated arms which present at least one hinge 70 attached to a rigid frame, for instance a U shaped structure 75. In other examples, such arms might be extendable due to a telescopic structure. The handling robot displaces frame-mounted pins 7a by dragging them to the desired position. This may be performed, for instance, by a rod which may be attached to the handling robot 5a to be insertable in a corresponding opening in the centering pin, such that the robot can engage the pin and drag it to a target position. The stacking system may include a lock for releasably locking the articulated arms, in order to temporarily fix the position of each frame-mounted pin 7a before the stacking operation may start. For example, the releasable locking may be implemented by a pneumatic cylinder mechanism. The articulated arms may be located in correspondence with at least one side of a support 3.

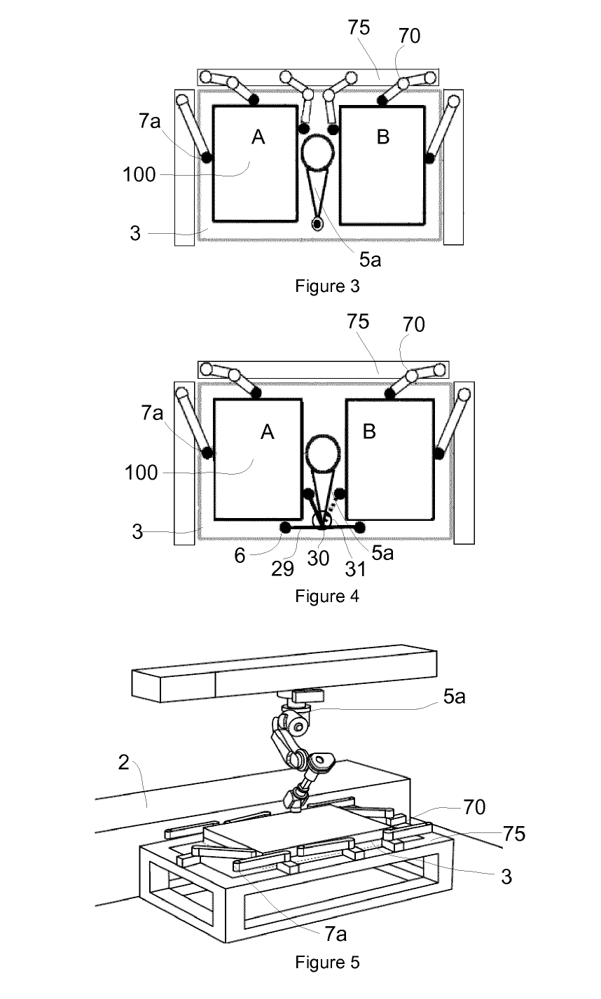

The adjustable centering pins provided by the handling robot 5a may be associated to one or more stacks on a stacking support 3, such as stacks A and B in FIG. 2A. For this purpose, the roof-mounted handling robot 5a may be located in correspondence with the center of a stacking support 3, as shown in FIGS. 2A and 3. In such case, the robot may displace and position the pins for stacks A and B alternately.

FIG. 3 is a schematic drawing of a stacking line system according to examples of the disclosure. This example is analogous to those illustrated in FIGS. 2A and 2B, but for pins 7a having magnets. As previously mentioned, a handling robot 5a displaces and positions the frame-mounted adjustable pins. Then the articulated arms are releasably locked by the system before the stacking operation starts. The number of arms provided in this case may be for example of two or three, because pins 7a are magnetic and therefore attract the blanks 100. Due to their magnetic nature, the number of arms provided may be lower than in non-magnetic pins examples seen above.

FIG. 4 shows a schematic drawing according to a further example of the disclosure. In this case, a handling robot 5a may be roof-mounted and arranged in correspondence with the center of a stacking support 3, and may be configured to displace and position the adjustable frame-mounted pins 7a to be associated with one or more stacks A, B on two or three sides of the stacking support 3. Moreover, it may hold adjustable robot-mounted pins 6 during the stacking operation in correspondence with at least another side of the support.

In this example, the handling robot 5a may include a wrist mount 30 located at its distal end. A tooling, e.g. a tooling 29 provided with pins 6 suitable for adjusting the position of blanks 100 may be attached to the wrist mount 30. This tooling 29 may include four or six arms, of which three are configured to hold pins 6, and one or two arms may hold rods suitable for displacing and positioning frame-mounted pins 7a. Alternatively, the one or two rods might be attached to the handling robot 5a by other methods or structures different from tooling 29. Once the handling robot 5a has displaced and positioned the above described frame-mounted pins 7a on the desired locations before the start of the stacking operation, it may proceed to positioning the robot-mounted adjustable pins 6 and hold them in place during the stacking operation. Using the handling robot for setting the position of the frame-mounted pins and also for holding pins during stacking operation allows reducing the number of frame-mounted pins 7a. For example, only two such frame-mounted pins attached to articulated arms are present in the embodiment of FIG. 4.

After each one of the blanks has been stacked, the robot may push the blank towards the frame-mounted pins 7a by pressing the robot-mounted pins 6 against the side of the blank. Thus, an utmost accurate alignment of each blank with the rest of the stack may be achieved.

In case the blanks are placed on two adjacent stacks on the support 3, the tooling may be rotated and moved alternatively towards one stack or the other, in order to guide each blank that is being stacked. In yet a further example, the wrist mounted tooling may be provided with four pins 6, thus minimizing the rotation of the tooling for each blank. This may be convenient for example in the case of small dimension blanks, in which case the translation and rotation movements of the tooling by the handling robot might be considerably large. This means that the example might minimize the robot's rotation movement, ensuring that it does not exceed the stacking cycle time.

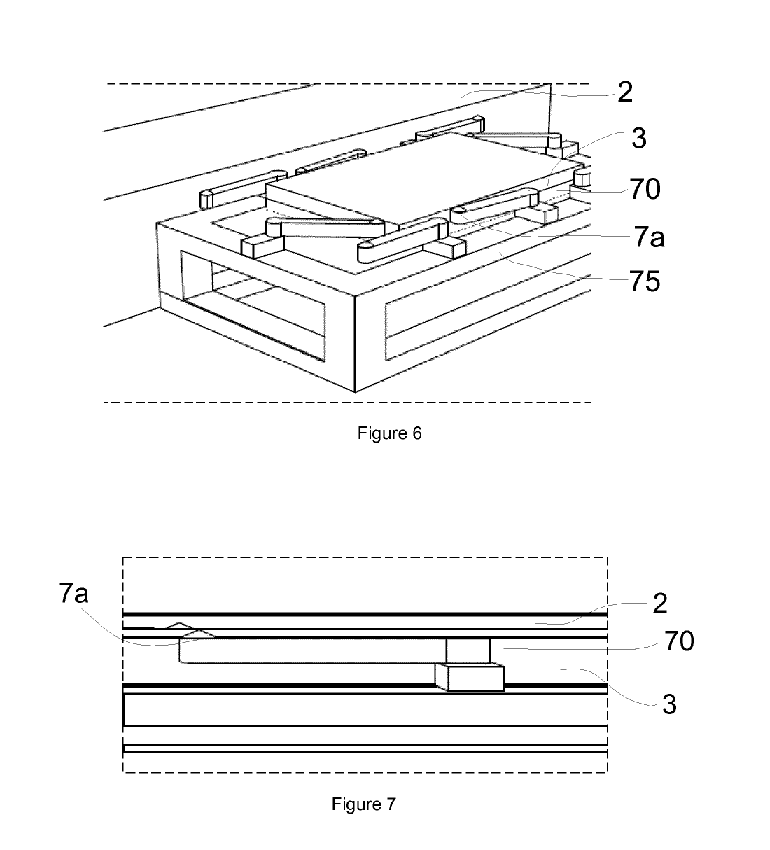

FIGS. 5 and 6 illustrate a perspective view of a stacking line system according to an example, with adjustable frame-mounted pins 7a mounted on a rectangular frame 75. In this example, the roof-mounted handling robot 5a may set the position of eight frame-mounted pins, which are located around the four sides of the stacking support 3. The system is thus provided with eight frame-mounted pins because it is prepared for the case of two smaller blank stacks, in which case four pins would be required for each stack. In this case, only four pins 7a at the center of each stacking support side are in an active position, because the blanks are smaller than the maximum blank size capacity of the support. FIG. 7 illustrates an adjustable frame-mounted pin 7a in detail.

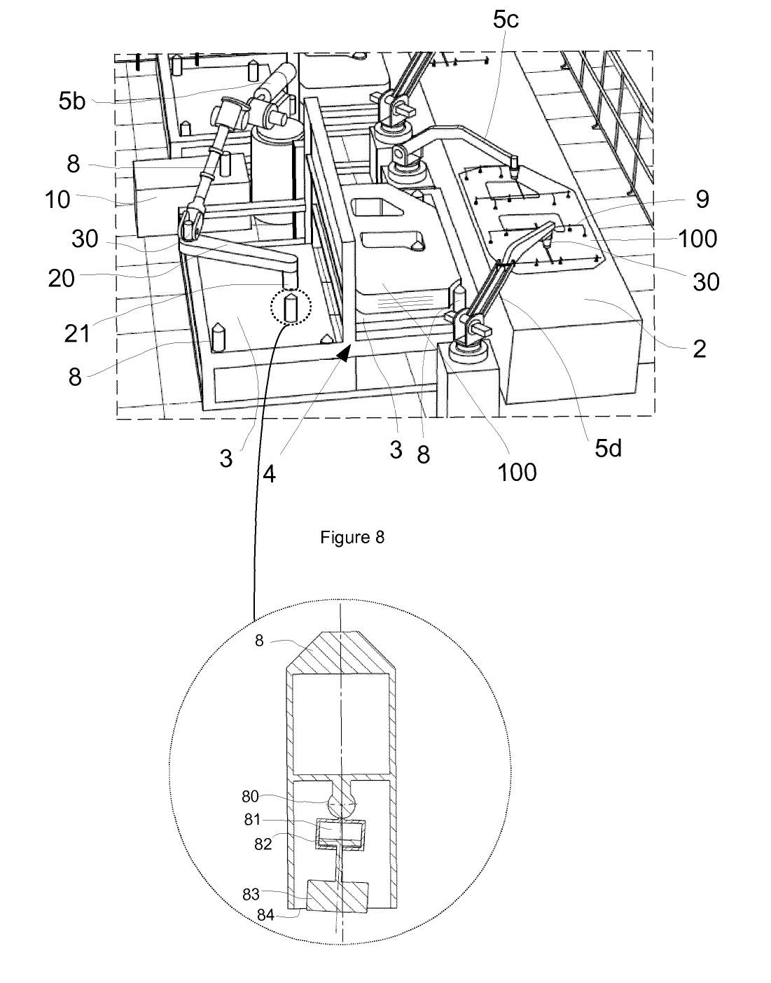

FIG. 8 shows a perspective view of a stacking line system according to an example of the present subject matter, which may be arranged at the outlet of a blanking shear or press in order to stack the blanks 100 that are outputted from the blanking shear or press (not shown) on stacking supports 3. In this case the adjustable centering pins are detached pins 8 intended to be attached to the surface of the stacking support 3. In this example the detached centering pins 8 may be configured to be attached to the stacking support in a releasable fashion.

More particularly, FIG. 8 shows schematically a transfer unit 2, which receives blanks 100 outputted from the blanking shear or press, and from which stacking robots 5c, 5d pick the blanks 100 in order to stack them, as will be described in the following.

The transfer unit 2 may e.g. be a stationary surface, where all the blanks are received and then picked in the same position; it may be a linear conveyor arranged to transport the blanks 100 along a transport path as shown in FIG. 8, from where they are picked by the stacking robots 5c, 5d.

The stacking robots may be two serial robots 5c, 5d, each with at least four axes (for example four rotational axes as in robots in FIG. 8), and they may comprise a wrist mount 30 located at its distal end. A tooling 9 e.g. with magnet or suction cups suitable for picking blanks 100 may be attached to the wrist mount 30.

The stacking robots may also be roof mounted, so as to be a smaller hindrance.

An example of a serial robot that may be employed as a stacking robot in a stacking line system such as that of FIGS. 8, 9A, 9B and 10 is robot IRB 460, available from ABB (www.abb.com).

Stacking robots 5c and 5d may be controlled by a controller (not shown) to each pick a blank 100 from the transfer unit 2, or to pick a blank 100 between them, as shown in FIG. 8, and place it on an associated stacking support 3.

Handling robots 5b may be controlled by a controller (not shown) to pick detached centering pins 8 from a pin's store 10 and place them on an associated stacking support 3. The pin's store can be e.g. a surface located besides the handling robot's base and the stacking support 3, according to the best convenience. The handling robot 5b may include a wrist mount 30 located at its distal end. An arm 20 provided with a tool 21 at its distal end suitable for picking pins 8 may be attached to the wrist mount 30. The tool 21 may be e.g. an electromagnet based device to pick and place magnetic pins 8.

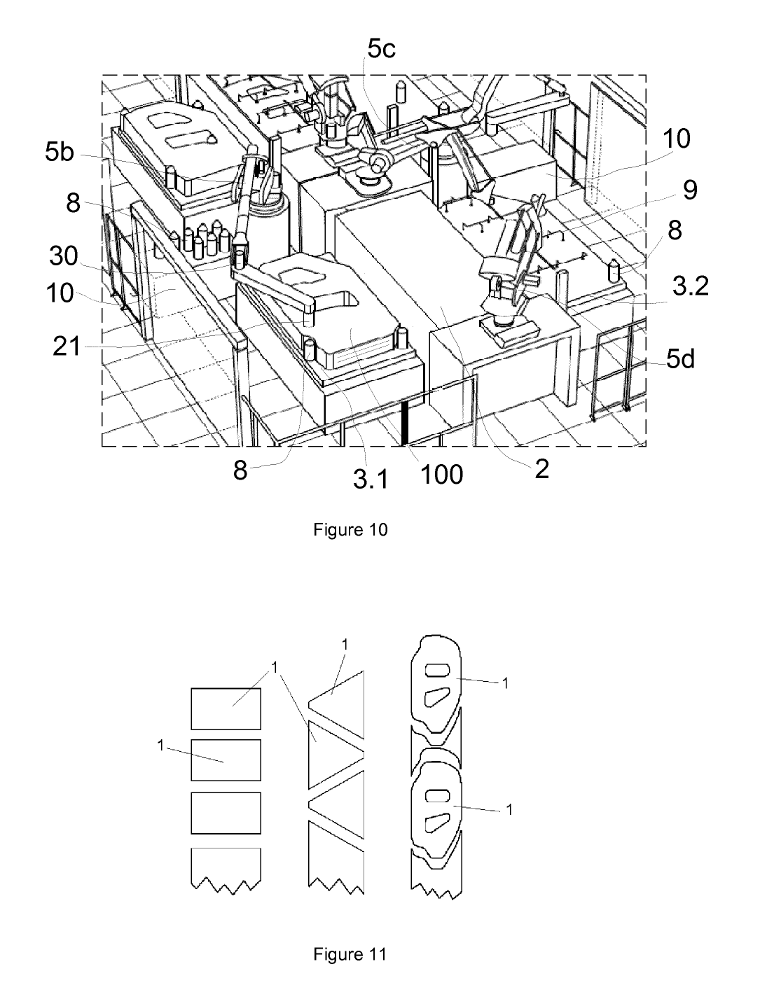

More particularly, FIG. 8 shows stacking supports 3 that may be made of a ferromagnetic material, and the detached centering pins 8 may include magnetic releasable elements, for example, based on a pneumatic cylinder mechanism. The enlarged detail of FIG. 8 illustrates an example of a detached pin with an inner releasable magnet including a pneumatic element. In the figure, a detached pin 8 includes a pneumatic cylinder 82, with an air chamber 81, a magnet 83 and an opening 84. When the air chamber is empty, the cylinder is in its uppermost position, and the magnet 83 is at a distance from the opening 84 and therefore is not able to exert an attracting force towards the stacking support (not shown). On the contrary, when air is inserted in the chamber 81, for example through a tube (not shown), the cylinder is pushed downwards, so that the magnet 83 protrudes from the opening 84 at the base of the pin and is thus able to contact a ferromagnetic stacking support 3 and to attach the pin to its surface. In some cases, the stacking support may have an uneven upper surface (e.g. a not machined metal base) and the magnet may assume an unlevelled position as shown in FIG. 10A. A levelling mechanism, in this example a ball joint 80, is foreseen so as to allow the pin to assume an upright position.

As the stacking support is ready for receiving the blanks, the handling robot picks up the pins and positions them singularly at their corresponding locations on the surface of the stacking support. The locations are predetermined according to the shape and size of the blanks, and may therefore be configured to any configuration which better suits the blanks centering requirements. This provides the system with high flexibility while maintaining an accuracy that may be satisfactory in some cases.

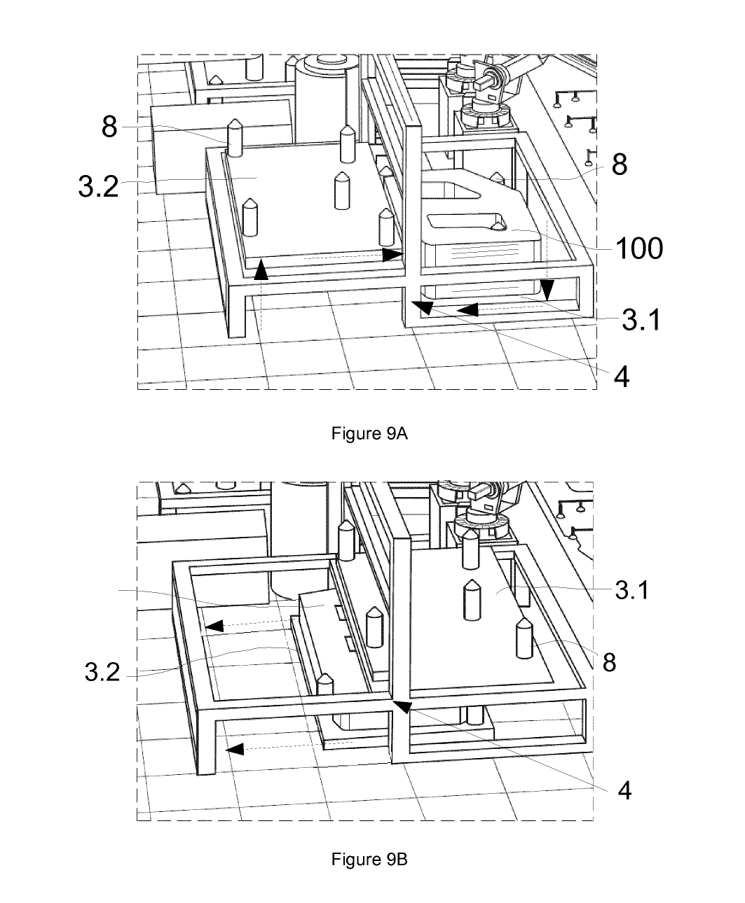

More particularly, FIGS. 9A and 9B show schematically the operation of a transporting device 4. The purpose of this example is to provide a solution in cases where the stacking line system presents only one operative side for arranging stacking supports 3 as shown in FIG. 8. In this example, at least two stacking supports 3.1 and 3.2 as shown in FIGS. 9A and 9B are configured to be moved alternately between a stacking position adjacent to the transfer unit and a pin-placing position to a greater distance from the transfer unit.

As in the example shown in FIGS. 9A and 9B, the two stacking supports 3.1 and 3.2 may move upwards and towards a stacking position adjacent to the transfer unit, and downwards and towards a pin-placing position to a greater distance from the transfer unit, respectively, as shown in FIG. 9A; Thus, the stacking supports 3.1 and 3.2 may be operated in an alternate mode, in which while stacking robots 5c, 5d pick blanks outputted from the line and place them on a stacking support, the handling robot 5b picks the centering pins 8 and places them on another empty stacking support. Such an operation increases the line velocity and allows for a high working efficiency.

Such alternate mode operation may be performed as described in the following sequence.
Detached centering pins 8 are releasably attached on a stacking support 3.2 by the handling robot 5b in the predetermined locations which correspond to the blanks to be stacked thereafter. In the meanwhile, blanks are being stacked on top of the stacking support 3.1;
after the stack on the stacking support 3.1 is complete and the pins are placed on support 3.2, the transporting device 4 moves the stacking supports 3.1 and 3.2 between the stacking position and the pin-placing position by the above described movements.
centering pins 8 are removed by the handling robot 5b from a stacking support 3.1 which contains a stack of blanks 100 and is located at a lowest and external position with respect to the transfer unit 2 (or pin-placing position);
the stacking support 3.1 with a stack of blanks 100 is removed by a forklift truck and replaced with a new, empty stacking support 3.

FIG. 10 illustrates a further example of a stacking line system with stacking supports 3 located at both sides of the stacking line system. In such example, the above mentioned transporting device 4 is not necessary. Instead, two handling robots 5b may be provided, one for each side of the transfer unit 2. Under operation, while the stacking support 3.2 at one first side is being filled with blanks, the stacking support 3.1 at one second side is being emptied.

Thus, after blanks have been stacked on the stacking support at the first side, the stacking robots 5c, 5d that pick blanks 100 from the transfer unit 2 initiate stacking the blanks on the second side, i.e., on the second stacking support 3 that has been previously prepared as by the sequence described in the following.

At a first side of the stacking line,
centering pins 8 are removed from a stacking support 3 on which a stack of blanks has just been completed by the handling robot 5b;
the support 3 is removed by forklift truck or the like (not shown) and a new stacking support 3 is provided;
centering pins 8 are releasably attached on the new stacking support 3 by the handling robot 5b in the predetermined locations which correspond to the blanks 100 to be stacked thereafter.

Simultaneously, at a second side of the stacking line, the stacking of the blanks is taking place until the stacking support 3 is ready for being removed.

In all of these examples, the handling robots may be SCARA (Selective Compliance Assembly Robot Arm) robots. The 3 axis present in these robots are sufficient for their function in these examples. SCARAs are generally faster and cleaner than comparable serial robot systems, as well as cheaper. Therefore, their implementation may provide an increase in accuracy and a reduction in costs.

Although only a number of particular examples and examples of the present subject matter have been disclosed herein, it will be understood by those skilled in this area that other alternative examples and/or uses of the present subject matter and obvious modifications and equivalents thereof are possible. Furthermore, the present subject matter covers all possible combinations of the particular examples described. Reference signs related to drawings and placed in parentheses in a claim, are solely for attempting to increase the intelligibility of the claim, and shall not be construed as limiting the scope of the claim. Thus, the scope of the present subject matter should not be limited by particular examples, but should be determined only by a fair reading of the claims that follow.

1. A stacking line system for stacking blanks outputted from a blanking shear or press, the stacking line system comprising
a transfer unit for receiving blanks outputted from the blanking shear or press;
at least one stacking support for stacking blanks thereon;
one or more stacking robots to pick blanks from the transfer unit and place them on the stacking support; and
a blanks guiding system comprising
at least one handling robot configured to position one or more adjustable centering pins for assisting the placement of the blanks on the stacking support.

2. A stacking line system according to claim 1, the blanks guiding system further comprising at least one fixed centering pin in a fixed position with respect to the stacking support.

3. A stacking line system according to claim 2 comprising two fixed centering pins that are respectively located in correspondence with two sides of the stacking support, and the handling robot being configured to position at least two adjustable centering pins in correspondence with other sides of the stacking support.

4. A stacking line system according to claim 2, the handling robot being configured to position at least one adjustable centering pin in correspondence with a side of the stacking support which is substantially orthogonal to a side of the stacking support having a fixed centering pin associated therewith, the fixed centering pins and the adjustable centering pins comprising magnets.

5. A stacking line system according to claim 1, the blanks guiding system comprising at least two handling robots, each configured to position adjustable centering pins in correspondence with two sides of the stacking support that are orthogonal to each other.

6. A stacking line system according to claim 1, the adjustable centering pins comprising frame-mounted pins attached to a frame of the guiding system through articulated arms or telescopic arms, said frame being arranged in the vicinity of the stacking support.

7. A stacking line system according to claim 6, comprising a lock for releasably locking the articulated arms to temporarily fix the position of each frame-mounted pin.

8. A stacking line system according to claim 6, the handling robot being configured to displace each frame-mounted pin to a predetermined position depending on the blanks to be stacked.

9. A stacking line system according to claim 6, at least one handling robot being configured to displace frame-mounted pins to predetermined positions in correspondence with at least one side of a support, and to position at least another adjustable centering pin in correspondence with at least another side of the support and hold it during stacking.

10. A stacking line system according to claim 1, the adjustable centering pins of the guiding system comprising detached pins configured to be releasably attached to the upper surface of the stacking support.

11. A stacking line system according to claim 10, each detached pin comprising a releasable magnetic element and the stacking support comprises a ferromagnetic material.

12. (canceled)

13. A stacking line system according to claim 10 comprising at least two stacking supports and a transporting device configured to move each stacking support between a stacking position and a pin-placing position, the stacking position being disposed adjacent to the transfer unit, and the pin-placing position being disposed at a greater distance from the transfer unit than the stacking position.

14. (canceled)

15. A stacking line system according to claim 1, the handling robots being robots.

16. A method for stacking blanks outputted from a blanking shear or press comprising:
providing a stacking support;
positioning one or more adjustable centering pins in correspondence with the stacking support, by a handling robot, in predetermined positions depending on the blanks to be stacked; and
stacking blanks on the stacking support by a stacking robot, such that the placement of the blanks on the stacking support is assisted by the adjustable centering pins.

17. A method as claimed in claim 16, comprising holding at least one centering pin by a handling robot while the blanks are being stacked.

18. A method as claimed in claim 17, comprising adjusting the position of each blank after it is placed on the stacking support by pushing it in a horizontal direction with the adjustable centering pins.

19. A method as claimed in claim 16 comprising releasably attaching a number of detached pins on the upper surface of a stacking support by a handling robot before stacking blanks on the stacking support.

20. A method as claimed in claim 19, comprising removing the detached pins from the stacking support by a handling robot after blanks have been stacked on the stacking support.

21. A method as claimed in claim 20, comprising one or more of:
providing a stacking support at a pin-placing position;
attaching a number of detached pins on the stacking support at the pin-placing position;
moving the stacking support to a stacking position;
stacking blanks on the stacking support at the stacking position;
moving the stacking support with the blanks back to the pin-placing position; and
removing the detached pins from the stacking support at the pin-placing position.

22. A method as claimed in claim 21, comprising one or more of:
providing at least two stacking supports;
attaching detached pins on one stacking support at the pin-placing position while stacking blanks on another stacking support at the stacking position; and
exchanging the position of the stacking supports.
